(19) United States
(12) Patent Application Publication
(10) Pub. No.: US 2004/0100442 A1
(43) Pub. Date: May 27, 2004

(54) Universal remote controller

(75) Inventor: Cheng-Si Wang, Changhua Hsien (TW)

Correspondence Address: Cooper & Dunham LLP, 1185 Avenue of the Americas, New York, NY, 10036, US

(73) Assignee: Trans Electric Co., Ltd.

(21) Appl. No.: 10/305,829

(22) Filed: Nov. 27, 2002

(51) Int. Cl. G09G 5/08

(52) U.S. Cl. 345/158

(57) ABSTRACT

A universal remote controller is provided. The remote controller comprises a signal processor, a power unit, a keypad, and an infrared emitter, wherein the keypad receives input keys and outputs corresponding electrical signals to the signal processor, and the signal processor processes the input signals and generates control signals to the infrared emitter, and the infrared emitter converts the control signals to radiant energy. The power unit provides the operating voltage for the signal processor. The signal processor is coupled with a non-volatile memory unit in which the parametric settings for operating the remote controller are saved. The preset values can be retained in the non-volatile memory without electric power supply, thus obviating the need to reset the preset values every time the remote controller is powered on.

### BACKGROUND OF THE INVENTION

1. Field of the Invention

The present invention relates to a universal remote controller, in particular to a remote controller that enables the preset values to be retained in a non-volatile memory even during power off, obviating the need to input the setting values every time when the remote controller is turned on.

2. Description of Related Arts

To enhance the remote control functions of existing electronic devices and electrical appliances, most of them have now incorporated some kind of remote controller in their latest versions. However, these remote controllers are each uniquely designed to suit the characteristics of their host machines, such that rarely can they be operated on different devices without modifications. This incompatibility of the control signals for operating different electronic and electrical devices makes it necessary for ordinary users to keep large numbers of remote controllers at the appropriate area to control different electrical and electronic devices, thus wasting resources and creating confusion.

A remote controller is created that can be universally applied on most electronic and electrical devices, consolidating most of the functions existing in various types of remote controllers with a programmable operation controller. Hence there is no more confusion in finding the right one among several controllers with high resemblance, and no problem with repairs and replacements for discontinued product lines.

When using the universal remote controller, one only needs to set up the parametric settings at the first time of use. Thereafter, these parametric settings will be remembered by the controller every time the power is turned on. For example, if the host machine is a television set, a user can select the favorite channels and save the channel values in the auto selection keys of the remote controller. When the controller and the television set both are powered on, a quick push on one of the preset keys will enable the controller to recall the favorite channel on the television screen.

The only problem with the above universal remote controller is that the preset value saved in the memory will be lost when the internal battery in the remote controller is depleted, or removed during battery replacement. The parametric settings have to be recreated by the user manually, thus adding inconvenience in operating the remote controller.

The present invention is to address the above-mentioned drawbacks.

### SUMMARY OF THE INVENTION

The main object of the present invention is to provide a remote controller that can retain the preset values in the memory during power off, so that the remote controller will be able to remember the preset values every time when the power is turned on.

The present invention can be used for controlling the operation of most television sets, audio equipment, video players and recorders, and other consumer electronics and household appliances.

The universal remote controller comprises:

a signal processor implemented by an integrated device;

a non-volatile memory unit for retaining the preset values after power off;

a power unit for providing the operating voltage of the signal processor;

a keypad for outputting electrical signals to the signal processor when the corresponding function keys are pressed;

an infrared emitter for generating infrared signals; and

a memory unit possessing the non-volatile memory characteristics, whereby the preset values of the controller can be retained even after power off.

The above-mentioned non-volatile memory is implemented by electrically erasable programmable read-only memory (EEPROM).

The features and structure of the present invention will be more clearly understood when taken in conjunction with the accompanying figures.

### BRIEF DESCRIPTION OF THE DRAWINGS

FIG. 1 is a detailed circuit diagram of the present invention.

### DETAILED DESCRIPTION OF THE PREFERRED EMBODIMENT

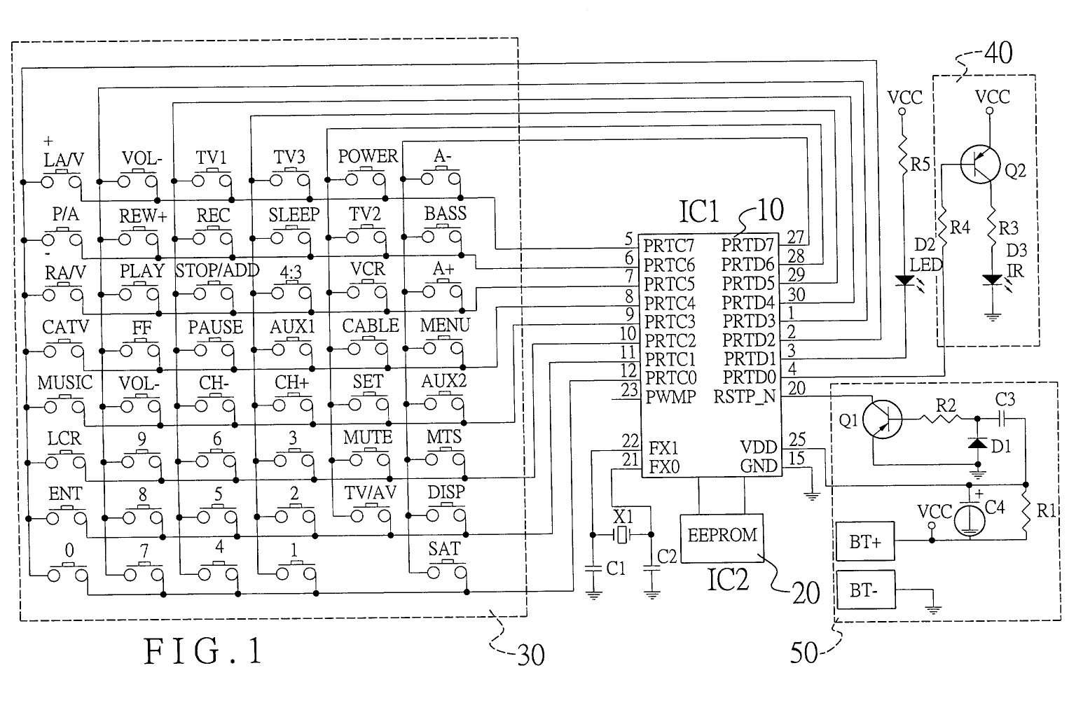

With reference to FIG. 1, the universal remote controller comprises a signal processor (10), a non-volatile memory (20), a power unit (50), a keypad (30) and an infrared emitter (40).

The signal processor (10) is formed by an integrated device that receives electrical signals from key input and generates signals for controlling the operation of the host machine.

The non-volatile memory (20) is used to retain the preset values after power off. Its non-volatile memory characteristics enable the controller to retain the preset values even after power off, which are programmable or electrically erasable by applying a predetermined voltage on the selected input lines. In the current embodiment, the above memory is implemented by an electrically erasable programmable read-only memory (EEPROM).

The keypad (30) is made up of multiple numeral and function keys respectively connected to the corresponding input of the signal processor (10). The keypad (30) receives key inputs and outputs corresponding electrical signals to the signal processor (10).

The infrared emitter (40) is connected to the output of the signal processor (10) to generate infrared signals with different wavelengths to control the operation of the host machine.

The power unit (50) provides the operating voltage for the signal processor (10) by connecting to the power input of the signal processor (10). In the current embodiment, the internal power for the remote controller typically comes from a storage battery.

Based on the above architecture, a user operating the universal remote controller only needs to set up the parametric settings at the first time of use by inputting certain values through selected keys of the keypad (30) to the signal processor (10). Thereafter, these preset values will be remembered by the controller every time it is powered on. The signal processor (10) saves the input values in the non-volatile memory (20) and recalls from there every time when the controller is powered on.

The foregoing description of the preferred embodiments of the present invention is intended to be illustrative only and, under no circumstances, should the scope of the present invention be so restricted.

What is claimed is:

1. A universal remote controller comprising
a signal processor implemented by an integrated device;
a non-volatile memory retaining settings values after power off;
a power unit providing an operating voltage for the signal processor;
a keypad receiving key inputs and outputting corresponding electrical signals to the signal processor; and
an infrared emitter receiving output signals from the signal processor and generating infrared signals.

2. The universal remote controller as claimed in claim 1, wherein the non-volatile memory is implemented by an electrically erasable programmable read-only memory (EEPROM).
